(19) United States
(12) Patent Application Publication
(10) Pub. No.: US 2015/0050631 A1
(43) Pub. Date: Feb. 19, 2015

(54) COLLEGE APPLICATION TUTORIAL SYSTEMS AND METHODS

(71) Applicant: COLLEGE ZOOM, INC., WOODLAND HILLS, CA (US)

(72) Inventor: David REYNALDO, WOODLAND HILLS, CA (US)

(21) Appl. No.: 14/455,619

(22) Filed: Aug. 8, 2014

Related U.S. Application Data
(60) Provisional application No. 61/865,540, filed on Aug. 13, 2013.

(51) Int. Cl. G09B 7/02; G09B 5/06

(52) U.S. Cl. CPC G09B 7/02; G09B 5/06
USPC 434/308

(57) ABSTRACT

Methods and systems for interactive web based tutorials are described, to create, manage, facilitate, and develop the writing of the written components of admissions applications. Examples of the tutorials include managing essays, activity summaries, resumes, and other written responses required by admissions applications including their supplemental applications.

### CROSS REFERENCE TO RELATED APPLICATIONS

The present application claims priority to U.S. Provisional Patent Application No. 61/865,540, filed on Aug. 13, 2013, the disclosure of which is incorporated herein by reference in its entirety.

### TECHNICAL FIELD

The present disclosure relates to systems and methods for formulaically creating, managing, and developing unique writing for the written components of admissions applications. More specifically, it relates to college application tutorial systems and methods.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 depicts an example embodiment with different regions of a user interface for the tutorial system.

FIG. 2 illustrates example embodiment, a screenshot taken from a tutorial system in use.

FIG. 3 illustrates an example of detailing of an activity.

FIG. 4 illustrates an example of a transfer from a resource box to a word processor.

FIGS. 5 and 6 illustrate an example of table filling.

FIG. 7 illustrates an example of a five-paragraph structure.

FIG. 8 illustrates an example of a web-based tutorial system.

FIG. 9 illustrates an example of a hardware implementation of the disclosure.

FIG. 10 illustrates an example of an instructional method used by the tutorial.

FIG. 11 illustrates a method to iteratively narrow a shared understanding between the student or user of the tutorial system, and the tutorial system itself.

### SUMMARY

In a first aspect of the disclosure, a tutorial system for formulaic writing of content for written components of school applications is described, the tutorial system comprising a display system configured to produce a display, the display including: a first display region configured for word processing; a second display region configured for providing audio and/or video instructions; a third display region comprising a next step button; a fourth display region comprising a back step button; a fifth display region configured for providing resources, wherein the resources comprise models and/or templates, and further comprises a cycle button configured to enable the user to cycle through different resources; a sixth display region comprising a transfer button, wherein the use of the transfer button causes: a transfer of resources from the fifth display region into the first display region or copies the resource from the fifth display region so the user can manually paste the resource into the first display region; and a seventh display region, comprising menu options.

In a second aspect of the disclosure, a web-based tutorial system for formulaic writing of unique content for written components of school applications is described, the tutorial system comprising: a tutorial system device, comprising a display system configured to produce a display, wherein the display includes: a first display region configured for word processing; a second display region configured for providing audio and/or video instructions; a third display region comprising a next step button; a fourth display region comprising a back step button; a fifth display region configured for providing resources, wherein the resources comprise models and/or templates, and further comprises a cycle button to cycle through different resources; a sixth display region comprising a transfer button, wherein the transfer button: transfers resources from the fifth display region into the first display region or copies the resource from the fifth display region so the user can manually paste the resource into the first display region; a seventh display region, comprising menu options; a tutorial system server, wherein the server is configured to provide resources and algorithms to the tutorial system device; wherein the tutorial system device and the tutorial system server are configured to communicate with each other.

In a third aspect of the disclosure a method for tutoring students in formulaic writing of unique content for written components of school applications is described, the method comprising: providing a computer running a web based tutorial system; tutoring, by the computer, a student in organizing a list of required activities by dividing the list of required activities into a first set of sequential steps, wherein the first set of sequential steps comprises a first set of sequential substeps; tutoring, by the computer, a student in developing a description for each required activity by completing a first template in a second set of sequential steps, wherein the second set of sequential steps comprises a second set of sequential substeps; tutoring, by the computer, a student in finalizing a description for each required activity by applying self-evaluation tools in a third set of sequential steps, wherein the third set of sequential steps comprises a third set of sequential substeps; tutoring, by the computer, a student in interpreting a prompt from an application by pairing the application with an alternative prompt or template; tutoring, by the computer, a student in brainstorming experiences to write a story about, by prompting the student with examples or templates of types of experiences that the student is asked to recall parallel experiences from in a fourth set of sequential steps, wherein the fourth set of sequential steps comprises a fourth set of sequential substeps; tutoring, by the computer, a student in finding a storyline in any brainstormed experience by completing a second template in a fifth set of sequential steps, wherein the fifth set of sequential steps comprises a fifth set of sequential substeps; tutoring, by the computer, a student in choosing one of the brainstormed experiences to write a story about, by having the student apply self-evaluation tools in a sixth set of sequential steps, wherein the sixth set of sequential steps comprises a sixth set of sequential substeps; tutoring, by the computer, a student in outlining an essay by having the student complete each field of a table with multiple rows and columns in a seventh set of sequential steps, wherein the seventh set of sequential steps comprises a seventh set of sequential substeps; tutoring, by the computer, a student in outlining an essay by using the information from the table to complete a third template in an eighth set of sequential steps, wherein the eighth set of sequential steps comprises an eighth set of sequential substeps; tutoring, by the computer, a student in developing a draft of an essay by having the student use a fourth template to write the essay in a ninth set of sequential steps, wherein the ninth set of sequential steps comprises a ninth set of sequential substeps; and tutoring, by the computer, the student in completing each of the sets of sequential steps and substeps, wherein the completing comprises, at each sequential step of each set of sequential steps, integrating said sequential step into the school application.

### DETAILED DESCRIPTION

To an applicant, composing the written components of an admissions application (for example a college application) in a way that admissions officers will deem to be the right combination of personality, substantial content, and compelling qualities can be a very subjective, complex, and daunting process. Because of the highly subjective nature of the process, most applicants prefer to work with a human counselor or writing coach over a web-program because the human mind has the ability to evaluate the emotional qualities in a work of writing, and the human mind is also perceived to offer a higher level of interactivity, individualization, responsiveness, and quality than web-based tutorials that teach users through automated instruction. Both professional counselors and applicants have been able to agree that a web-program cannot rival the experience of working with a skilled human writing coach, until now. When users use the invention described in the present disclosure, they report feeling as though an actual person was helping them every step of the way.

In the present disclosure systems and methods are described that enable a web-based tutorial with automated instruction to rival the level of interactivity, individualization, and quality that an applicant would expect of a skilled human writing coach. The systems and methods described in the present disclosure enable a web-based tutorial with automated instruction to exert an unprecedented degree of control over how users think and articulate themselves throughout a step-by-step process that guides them in formulaically creating, managing, developing, and facilitating unique written responses for the written components of college applications. This is achieved, for example, by managing and facilitating the creation, development, and revisions of essays, personal statements, statements of purpose, activity summaries, resumes, and other written responses required by admissions applications. Such systems and methods comprise web based tutorials which can prompt students: for example, to write and complete a college essay in a step-by-step, field-by-field, way.

The methods described in the present disclosure may comprise providing a computer running a web based tutorial system. The methods may comprise the following elements as described below.

A step-by-step lesson plan that starts from scratch, guides users through a sequence of steps wherein they methodically create, build, and develop each building-block component required for their larger work product, and concludes with the user developing a larger work product.

Each step may feature a video wherein verbal audio instruction can be accompanied by animated visuals, graphics, and/or text that illustrate each concept and lesson in order to achieve picture superiority effect (the idea that concepts conveyed in picture/illustration form are much more likely to be remembered by a user than if they are only presented in text form).

The audio/visual instructions may also ask the user questions. Even though it is fully automated, the methods of the present disclosure aim to engage and guide students the same way a human tutor using the Socratic Method would. When the tutorial cannot respond or provide feedback to the user in the manner an actual person would, it may supply the user with thought models, articulation models, YES/NO checklists, and/or rubrics (“evaluation tools”) the user can apply in the context of the instruction for self-evaluation, quality control, and grading. Such tools may be supplied to the user in the form of a template that can he copied and pasted into the user's work document or conveyed through the audio/visual instruction of the video.

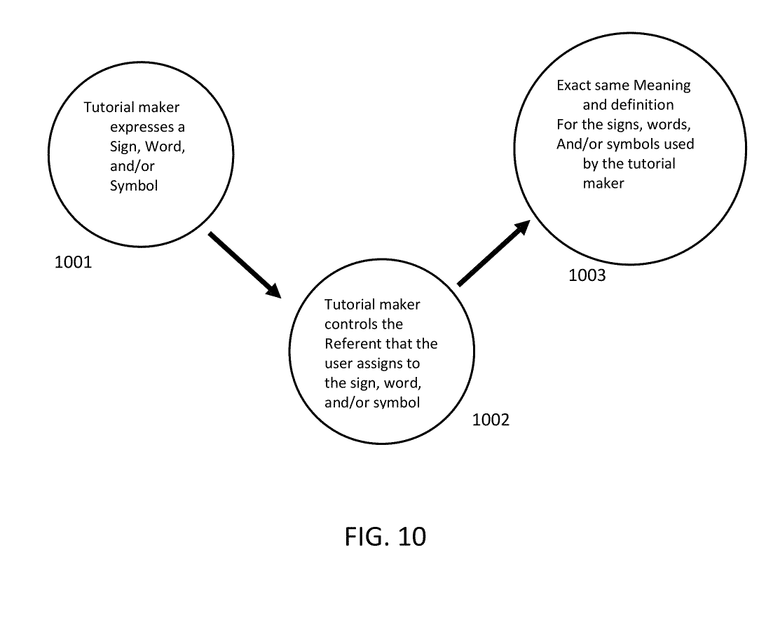

The audio/visual instructions may utilize the following model of communication, as detailed for example in FIG. 10. For example, a word, sign, or symbol may be expressed by the audio/visual instruction (1001) to explain a concept or idea. However, the definition the tutorial associates with the word, sign, or symbol it uses may be different from the user's definition for that same word, sign or symbol. Therefore, the audio/visual instruction uses verbal instructions accompanied by animated visuals, graphics, and/or text to establish a mutual definition, or “referent”, (1002) that both the tutorial maker and user's mind will both mentally “reference” whenever that word, sign or symbol is used. As a result, the tutorial maker's specific, intended definition of the word, sign, or symbol is now mutually understood and both the user and the tutorial maker share in the same meaning (1003). In other words: the tutorial maker is controlling what the user mentally references in his mind when he sees a sign, symbol, or word so that the tutorial maker and user share the exact same understanding. The benefit of this model is that it minimizes misunderstandings and enables the audio/visual instruction to tightly influence, dictate, and control the user's thoughts and actions.

For each building block component (of the larger work product) that a user needs to create, build, and develop: the tutorial can provide a template to the user which the user must copy and paste (or click to transfer) into his word processing document and use (as directed by the aforementioned audio and visual instruction) in order to create, build, and develop that building block component of the larger work product.

The transfer of the template purposely and necessarily incorporates the word processing document where the student will develop his work product. Associating the template (from an online tutorial that the student expects to passively engage with and passively learn from) with the word processing document (which past experiences have conditioned him to use whenever he wants to get work done—like homework or a paper for school) physiologically forces the user who completes the action of the transfer (i,e. a “trigger” action) to become an actively engaged learner who is ready to “do work”, thereby disrupting him from the state of passively listening and clicking through without being as actively engaged. Alternatively, the template (or templates) may be preloaded into a word processor (removing the need for the user to transfer it from the tutorial to the word processing document). The student would be provided this word processing document to build his work product in it. In another alternative, the student may first transfer the template into a word processor (that is not the one where he will develop his larger work product) and then (automatically or manually) transfer the template's work product into another word processor where the larger work product will be assembled or built. Regardless of how the template is inserted into the word processor, when the template is transferred into the word processor, it serves as a technical advancement to the word processing document because it provides structure, writing guides, and limitations to the workspace that did not previously exist there.

The template that the user transfers into the word processing document is designed to specifically and narrowly focus the user's attention on developing a building-block component (of the larger work product) in isolation of the larger work product.

The audio/visual instruction and the way the steps of the tutorial are separated (note: “separated” here means the way a user has to do the work of one step before he clicks next to do the work of the next step):

A) closely controls the user's navigation through (and completion of) the template,

B) may make the user further compartmentalize the template into several parts and then guide the user in creating, building, and developing each part in isolation before moving onto the next part/step (By controlling the order in which the user works through the template's parts, the benefit gained is minimizing information overload and avoiding analysis paralysis, while also ensuring that the user does things in the proper formulaic order) and

C) may tightly influence and highly control what the student will precisely think about and reference from his/her past experiences when completing each part of the template.

Further, the audio/visual instruction may aid in the user's completion of the template by conveying or depicting thought models (depicting thought processes the user is told to adhere to) and/or articulation models (depicting ways of articulating thoughts or forming sentences that the user should use to articulate himself). When used in conjunction with the templates, which set parameters the user must work within, the manner in which the user chooses to articulate himself/herself may be more tightly controlled and influenced.

Essentially, the user is being told what to pay attention to, what to do, and when to do it while concurrently being told how to think, what to think about, and how to articulate his thoughts in the word processing document. This is the way users may also be instructed to revise and edit their work.

Once the user fully completes the template he was given for one component of his larger work product, the user moves onto another template to build another component of the larger work product. This sequence is repeated in a formulaic fashion until the larger work product can be (or is) assembled.

When it is time for the user to assemble or incorporate the components into the larger work product, the user does so under Audio/visual instruction and guidance from the system.

Once the larger work product has been assembled, the user may be walked step-by-step in applying a self-evaluation rubric, thought model, a YES/NO checklist, and/or some other test to formulaically evaluate the quality of the work product. These tests may also appear prior to the conclusion of the larger work product to evaluate a specific component the user develops.

Most tutorials give the user a template to use as a starting point from which the user builds his work product largely unassisted. As described above in the present disclosure, this tutorial has the user follow one or more sequential steps to systematically create and assemble his work product within the template piece by piece. In other words, the user completes each part of the template in piecemeal as he progresses through each step. This way, the tutorial can be very specific about how each piece of the template should be created or developed by the user.

As described above in the present disclosure, each step may also convey audio/visual and/or text instructions to instruct the user on how to more specifically fill out each part of the template. The audio/visual instruction may convey thought models (depicting thought processes the user is told to adhere to) and/or articulation models (depicting ways of articulating thoughts or forming sentences that the user should use to articulate himself). When used in conjunction with the templates, which set parameters the user must work within, the manner in which the user chooses to articulate himself may be tightly controlled and influenced.

The methods and systems of the present disclosure can be extended to assist with he formulaic writing of unique content for the written components of: job applications, high school admissions applications, undergraduate college admissions applications, graduate school admissions applications, PhD program admissions applications, and any other forms, documents, or applications that have written components (for example resumes and cover letters for seeking employment). The methods and systems of the present disclosure can also be extended to assist with the formulaic writing of unique content for any work of writing.

In some embodiments of the present disclosure, a tutorial system can be employed to help students complete an activity sheet, resume, cover letter, supplemental essay, letter of recommendation, or a list of short answer responses. A tutorial system can also be used to complete additional and/or optional information sections.

A tutorial system can coach, for example, high school and community college students in how to develop college admissions applications for selective four-year colleges and universities. In order for students to be successful in gaining an edge in the admissions process and increase their chances of acceptance to competitive schools, the students may need to respond to the instructions, prompting, or questions asked by their admissions applications in a distinct or unique way. Such distinct or unique way may be different or non-obvious from the directions described by the very instructions contained in the application forms (not to mention the instructions provided to students in-person by their own English class teachers and college counselors). The methods, strategies, models, outlines, and algorithms described in the disclosure may be followed by students instead of the instructions contained in the application forms provided by the colleges, institutions, or jobs they are applying to. In other words, the disclosure comprises an alternative set of instructions for students to follow to complete their admissions applications.

In the present disclosure, supplemental, additional, and/or optional written response or information sections of admissions applications are referred to as “Additional Components”. These Additional Components, together with other required components of admissions applications, such as essays, are collectively referred to hereafter as “Admissions Application Components”.

The tutorial systems and methods of the present disclosure break down the writing process for each Admissions Application Component into simple steps that guide the user through unique processes and algorithms. In some embodiments, the tutorial system may also integrate a third-party evaluation or third-party evaluation applications, to ensure the student has written a compelling application.

In several embodiments, the tutorial system for creating each Admissions Application Component follows these key steps:
1) The user follows sequential steps provided by the tutorial system which require the user to transfer templates, models, and/or guides from the tutorial window into the user's word processor;
2) The user uses the templates, models, and/or guides as a guide for developing a part of the Admissions Application Component before continuing onto the next step.
3) Once a completed draft has been assembled, the user receives feedback in one of three ways: a) the user applies the self-evaluation tools, b) the user hires a human practitioner to review the work or c) the user follows steps provided by the tutorial on how to ask specific questions to other third parties (e.g. friends, family, teachers, etc.) that will solicit the best feedback from non-paid, human helpers.

Regarding step 2), in some embodiments of the disclosure, the tutorial system has a master template for writing each Admissions Application Component. However, instead of giving the user the master template in its entirety to work on all at once, the tutorial system may gradually transfer parts of the master template to the user, so that, at each step, a part of the template is employed separately by the user. In another embodiment of the invention, the master template may be fully previewed or provided at the beginning of the tutorial in such a way that the user can still work in a focused, methodical way that allows him to develop each step in isolation from the others, thereby facilitating concentration on the task at hand.

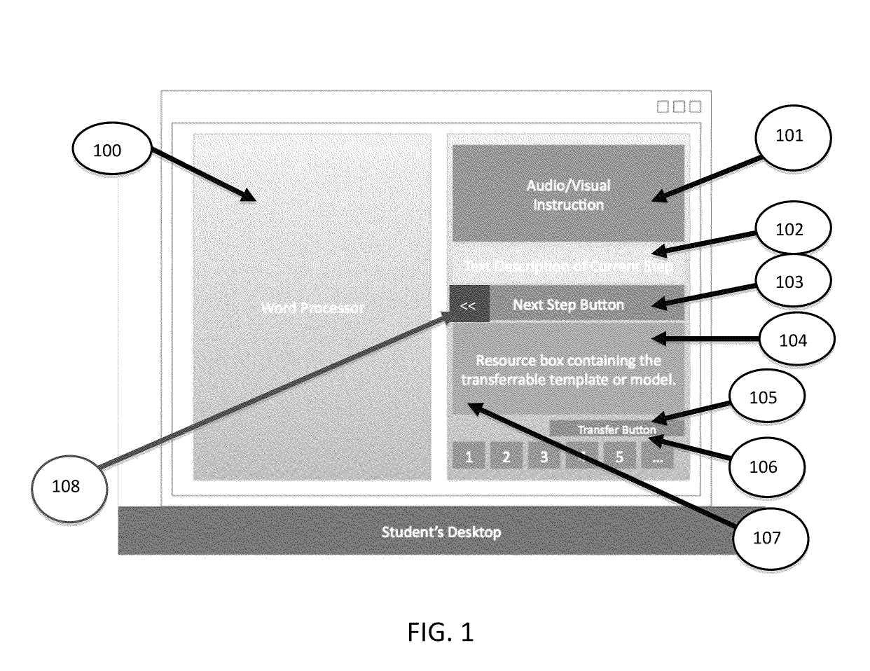

FIG. 1 illustrates one embodiment of the tutorial system, where several regions are visible, each region devoted to a specific function. In FIG. 1, a word processor is shown. Such word processor may be native to the student's computer as a separate application (like Microsoft Word, Macintosh Pages, or a Google Document) which is integrated with the tutorial system. In other embodiments, the word-processing capability may be built-in in the tutorial system.

One embodiment of a device for delivering the tutorial system of the disclosure, as described in FIG. 1, comprises a split-screen arrangement, set up on a personal computer screen, tablet, or other mobile device. Such arrangement may comprise one portion of the screen as the tutorial system and another part of the screen as a word processor. Alternatively, the tutorial may be displayed on a personal computer screen, mobile device, or tablet, and the word processor may be opened on another, separate device.

In FIG. 1, a word processor (100) occupies a region of the screen. Another region (101) may comprise Audio/Visual (AV) instructions. The AV instructions (101) may deliver a lesson plan to the user and instruct the user when to transfer templates and/or models from the resource box (104) into the word processor (100). Another embodiment of the invention may cue the user to transfer templates, models, and/or guides using a sign, image, sound, or other audio and/or or visual signal. The AV instructions (101) may also instruct the user as to where specifically place each template, model, and/or guide from the resource box (104) in the word processor (100). Such process can be implemented with either a native or built-in word processor. Alternatively, the transfer could also happen automatically upon the user clicking a Next Step button (103) and entering the next step. The instructions also guide the user in how to use the model, template, or guide to develop the specific work-product (such as an essay). In some embodiments, the resource box (104) may also incorporate a word processor.

The tutorial system may also include a region (102) with a textual description of the current step so the user can tell what the step entails at a glance. Another region may comprise a Next Step short-cut button (103) that takes the user to the next step in the process.

A resource box (104) may contain transferrable templates, guides, or models. The resource box (104) may also contain an algorithm, model, guide, scaffold, or formula that is expressed textually. It may also contain examples, audio/visual instruction, hyperlinks to external web resources, anecdotes, helpful advice, quotes, etc. In other words, the resource box (104) may contain any kind of resource useful to the process at hand, as understood by a person skilled in the art. In another embodiment of the invention, the resource box may also be a text box or word processor that the user can directly develop a work product within, which can be transferred into a word processor automatically or manually. In another embodiment of the invention, instead of transferring guides, templates, or models into a word processor to be developed, the user first develops the guide, template, or model inside of the word processor associated with the resource box and then transfers the result to a word processor.

Another region of the tutorial system may contain a transfer button (105) that allows the student to transfer the model, outline, or other resources from the resource box (104) into the word processor (100). The transfer button (105) may also copy the resource (104) upon being clicked so the user may paste the resource manually into a word processor (100). Another region may comprise a step navigation menu (106) for users to precisely navigate and jump to any step in the tutorial.

The resource box (104) may also include a ‘cycle’ feature control (107) that allows students to cycle through numerous models, templates, examples, resources, etc. that are embedded for the same step of the tutorial. A back step button (108) may also be present.

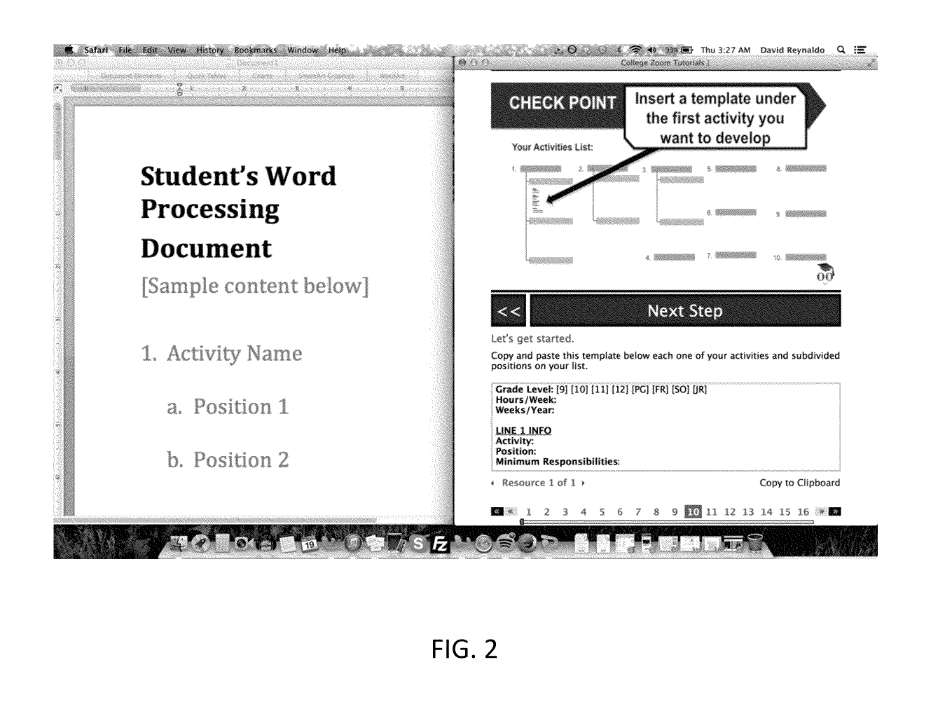

FIG. 2 illustrates an example embodiment of the disclosure, a screenshot taken from a tutorial system in use.

The tutorial system of the disclosure instructs students on how to develop their Admissions Application Components and comprises several features, for example:
a. Instructions provided to users: In guiding students to develop written responses for their Admissions Application Components, the tutorial system may provide alternative prompts for users to follow, that are different from the prompts provided by the actual applications (e.g. the Common Application, University of California Application, and other college applications). The users may use these alternative prompts and directions instead of the application's prompts or directions. Although the prompts of the tutorial system may be different from the standard application's prompts, they will ultimately answer or satisfy the questions or requests being asked by the admissions application.
b. Philosophical counseling approach: The standard belief in the college counseling industry among professionals is that no model for the perfect college essay exists. In fact, college counseling certification programs for aspiring counselors and college admissions officers advise that there is no right or wrong way for a student to express himself or herself in a personal statement, and the student should write on whichever topic he or she feels is personally meaningful to him or her. Students are also told to try and be unique and creative in their delivery. As a result of this industry-wide mentality, the advice practitioners skilled in the art usually provide to applicants is generally hands-off when it carnes to the student's choice of essay direction, content, and structure (i.e. macro-editing) and hands-on when it comes to correcting improper syntax and grammar usage micro-editing). The tutorial system of the disclosure is the first of its kind to provide unique, hands-on instruction when it comes to specifically guiding and/or controlling the student's choice of essay direction, content, and structure.
c. Method of having students work while they progress through the steps of the tutorial—not after they complete the tutorial: web-based college counseling tutorials that help students develop their college applications exist, but because of the aforementioned mentality of the industry, these programs offer very hands-on instruction when it comes to the student's choice of essay direction, content, and structure. These programs essentially resemble recorded lectures that dispense general advice that the student is supposed to implement on his own, either entirely or largely unassisted, once he finishes watching the program's videos, listening to its audio, or reading instructions. In the tutorial system of the disclosure, a step-by-step system is employed, where students develop an Admissions Application Component while they progress through the various steps of the tutorial so that when the program is completed, their work product is largely or entirely completed (as opposed to still being in early development).
d. Incorporation of a word processor into the apparatus: because having a student develop his Admissions Application Component as he progresses through the steps of a web-program is a non-obvious strategy for college counselors, professionals of ordinary skill in the college counseling industry have yet to see a benefit of having a word processor either 1) integrated into a web-based tutorial program or 2) used by students while they simultaneously complete the steps of the program. Hence, no web-based tutorial programs for admissions counseling have incorporated the use of word processors. Instead, the current web-based programs advise students to start writing or developing most, if not all, of their Admissions Application Components after the tutorial program concludes and many web-based programs recommend for students to seek the help of a coach if needed.

By the above advantages, the tutorial system of the present disclosure addresses the shortcomings of the prior art in using web-based programs to help students develop competitive and unique Admissions Application Components while feeling that an actual person is helping them through each step.

The tutorial system for each Admissions Application Component breaks the writing process for that Admissions Application Component down into various processes, models, and algorithms.

The Activity Sheet System. The following system helps students build and complete their activity sheet or resume entries for college applications. Rather than being a verbatim depiction of said system, the following representation depicts the general types of methods, models, templates, systems, and start-to-finish concept that are combined to control a user's thoughts and actions. In one embodiment, the system may comprise the following steps.

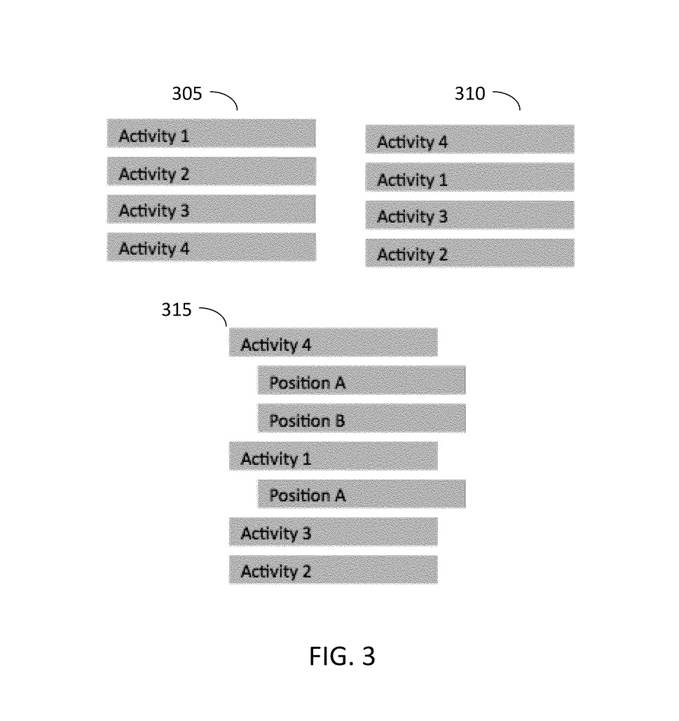

Step 1. The user will list all of the activities he or she has been involved in during a specified period of time. This is shown in (305) of FIG. 3. A resource may be provided in the resource box (104 of FIG. 1) that prompts the student with examples of types of activities so that he may recall parallel experiences that he would not have originally considered.

Step 2. The user will then rearrange the order of the activities listed in rank of most-to-least personally significant to the user. This is shown in (310) of FIG. 3. The user may be instructed to make prioritizations based on which activities he or she has invested the greater number of hours per week and/or weeks per year in, with higher rankings given to the activities that the user has invested more time in. The user may also be instructed to position similar but separate activities (e.g. a school debate club vs. a debate club the user participates in outside of school) close together in ranking (i.e. give them similar rank) on the list if they a) concern the same intrinsic activity, passion, or interest (e.g. both are essentially debate) and/or b) the time invested in the intrinsic activity, passion, or interest (when viewed holistically or collectively as debate) is substantially greater than the time invested in each individual, specific embodiment of the activity. For example, if a student is spending 20 hours a week on debate club at school and only 2 hours a week in a debate club outside of school, the two activities should be ranked closely together despite the significant difference in how many hours per week the student spends in each activity.

Step 3. The user will be instructed about how to know which activities can be subdivided further into separate activities. This is done to show instances where the user contributes an amount of value that one would normally expect of two or more people (i.e. the user wears more than one hat; fulfills more than one role). An example of step 3 may involve the following thought model:
a. A user being a Member of Club X. Being a member of Club X is a separate and distinct activity defined by the minimum requirements one needs to satisfy in order to be labeled a general member of Club X.
b. The same user also being the President of Club X. President is a separate and distinct activity which, outside of the minimum requirements of membership, carries additional minimum requirements expected of any person holding the position of President of Club X.
c. The same user also taking on one or more responsibilities that don't fall under the obligation of a president or general member of Club X (e.g. raising the bar by taking on additional fundraising obligations, community service planning, etc.).

FIG. 3 illustrates an example of step 3 in (315). Citing the example of Club X above, the user may be instructed to view every position held in Club X as a potentially separate and distinct activity that deserves its own activity sheet entry (or additional information highlight) in the user's college application.

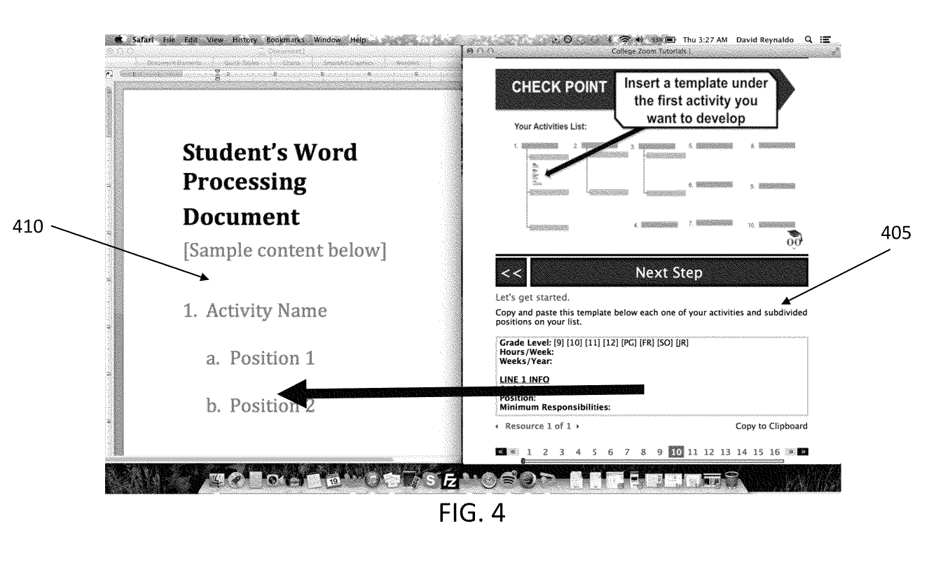

Step 4. Once every activity is appropriately sub-divided, the user can be instructed to outline notable talking points and details for each activity and position using, for example, the following base outline. For each activity, the user can transfer the base outline below from the resource box (104) to the word processor (100) of FIG. 1. Such a process is illustrated also in FIG. 4, where a base outline is transferred from region (405) to region (410). An outline example may be:
ACTIVITY NAME:
POSITION NAME:
MINIMUM CONTRIBUTIONS (the minimum requirements that another person needs to satisfy in order to claim the same title as you):
ABOVE MINIMUM CONTRIBUTIONS (anything you do that goes above those minimum requirements):
MOTIVATIONS:
EFFECT OF CONTRIBUTIONS (on the organization, or if not on the organization, then on you):
BEFORE VS. AFTER EFFECT (on the organization, or if not on the organization, then on you):
GIFTS APPLIED (personal strengths/skills you had to demonstrate):
RECOGNITION RECEIVED (can be formal or informal recognition):

Step 5: The user may be instructed on how to highlight the most compelling details and talking points of each activity by the AV instruction. The steps of the instruction may also be divided such that the user is guided in systematically completing this template in piecemeal. Once completed, user may be instructed to make, for example, two kinds of highlights: yellow and blue. Yellow=the detail needs to be included in the activity sheet description. Blue=the detail should be mentioned in the additional information section. Depending on the specific application, the user may make highlights in other colors to signify other categorizations and/or purposes for the information recalled. For example:
Activity name: (yellow highlight) Model UN.
Position name: (yellow highlight) President.
Motivations: interested in global politics, enjoyed Model UN as a member, want to understand how policies are made.
Minimum contributions: organized and ran all team meetings, managed logistics for all conferences.
Above minimum contributions: (yellow highlight) taught new members how to write position papers, coached team on public speaking, created fundraiser to cover travel expenses.
Effects of Contributions: (yellow highlight) most successful year in recent history, tutored three students who became selected for regionals, covered X % of travel expenses with fundraiser.
Before vs. After: (blue highlight) now, more students are running for officer positions and going to conferences.
Gifts Applied: building and developing people, sharing what I gained with others, motivating and inspiring, going above and beyond what the normal Model UN president does.
Recognition received: (yellow highlight) chosen for Outstanding Leader Award by school principal.

Step 6: The user may transfer a 2-line model from the resource box (405) into the word processor (410), referring to FIG. 4. This is essentially the format of the entry the user will be filling out in the application. Note: the specific type of template the user transfers at this point will depend on his application's formatting guidelines for the activity sheet or resume (i.e. it may be a 3-line model or any other kind of model). A 2-line model example would be:
Line 1: (50 character limit):
Line 2 (150 character limit):

Step 7: For lines 1 and 2, the user may be instructed to take the details that were previously highlighted in yellow and arrange them according to the following order (which may be conveyed in the resource box and/or through AV instruction):
Line 1 (50 character limit): [activity name], [your position], [minimum contributions]
Line 2 (150 character limit): [above minimum contributions], [effects of contributions], [before and after effect], [motivations]

For example:
Line 1 (50 character limit): Model UN, President, organized and ran all team meetings, managed logistics for all conferences.
Line 2 (150 character limit): (yellow highlight) taught new members how to write position papers, coached team on public speaking, created fundraiser to cover travel expenses, most successful year in recent history, tutored three students who became selected for regionals, covered X % of travel expenses with fundraiser, chosen for Outstanding Leader Award by school principal.

Step 8: the user may be instructed to re-arrange and modify the order suggested by step 7 in order to better show a cause-effect relationship between each detail that implies a linear story or establish better contrast between details or have certain details positioned earlier in the line so that they can provide context for subsequent details in the line.

Step 9: The user may be instructed to cut expressed details if they are implied by previously stated details. The AV instruction may examples, express models, templates, and guides for making such edits. For example in Line 1, because all presidents of student clubs organize and run team meetings, that detail can be cut. All Model UN presidents are also responsible for managing the logistics for all conferences. So that detail can be cut as well. The user may also be instructed on which details to move to additional information rather than cut:
Line 1 (50 character limit): Model UN, President, (the following is to be cut) organized and ran all team meetings, managed logistics for all conferences.

Step 10 The user may be instructed to cut words if the meaning the detail is intended to express is not lost (i.e. unnecessary words).

Step 11: The user may be instructed to paraphrase (i.e. say the same thing in less words).

Step 12: The user may be instructed to find shorter synonyms or alternative words (i.e. don't keep long words if shorter ones can be used).

Step 13: The user may be instructed to use well-understood abbreviations (i.e. ones where the abbreviated word is obvious to the lay person).

Step 14: The user may repeat steps 9 through 13 until lines 1 and 2 fit within the character limit enforced by the application's activity sheet entry. The user will also be told to view both lines as one continuous line, instead of two distinct entries, where one detail started on line 1 can be continued on line two. For example:

Line 1 (50 character limit): Pres., MUN, got principal's Outstanding

Line 2 (150 character limit): Leadership Award, coached team on writing position papers & public speaking: 3 made regional's, created fundraiser for travel, most successful yr

Step 15: Once lines 1 and 2 fit within the character count allotted by the user's chosen college application, the user will simply copy and paste the contents of lines 1 and 2 into the appropriate fields provided by their college application. That component of their work product is now complete.

Step 16: The user will repeat the above step for every other activity sheet or resume entry he or she needs to create.

The above steps 1 to 16 constitute an embodiment of an Activity Sheet System of the tutorial system of the present disclosure. Another system, part of the tutorial system, is the Essay Brainstorming System.

The Essay Brainstorming System. Instead of having students begin brainstorming essay or personal statement topics for the admissions application by using the application's prompts as a starting point (as the prior art does), the Essay Brainstorming System can provide students with separate, different, or supplemental prompts that can replace or be combined with the original prompts to help guide the student in uncovering uncover compelling plots and narratives in the student's life. This can happen before the student sees the admissions application essay prompts he or she will ultimately respond to. In this regard, it is possible to refer to the approach of the present disclosure as indirect, as opposed to the standard direct approach. The Essay Brainstorming System, described herein, helps students discover which experiences from their past have essay potential and then guides the student on how to choose “the right one” for their essay. In one embodiment, the Essay Brainstorming System comprises the following steps. However, rather than being a verbatim depiction of said system, the following representation depicts the general types of methods, models, templates, systems, start to finish concept that are combined to control a user's thoughts and actions.

Step 1. The user may be given an alternative prompt to pair with the prompt presented by his admissions application. For example: the official prompt might be, “Share a story that is central to your identity.” The user would insert this prompt into his word processor (100 of FIG. 1). Then, in the resource box (104 of FIG. 1), an alternative prompt would be provided. For example:
Alternative prompt: “How did a sequence of events develop a behavioral tendency in you that makes you more capable of being successful today and in the future?”
   The user would transfer this alternative prompt from the resource box to the word processor and read them together. This process is called “pairing”. For example:
Original prompt: Share a story that is central to your identity
Alternative prompt: “How did a sequence of events develop a behavioral tendency in you that makes you more capable of being successful today and in the future?”
   By reading the prompt from the application, which may be vague, with the alternative prompt, which is specific, the user is better focused and sees the prompt in a new light. In other cases, where the prompt is very vague, the user may be instructed to rely on the alternative prompt entirely and disregard the original prompt.

Step 2. The user may then be presented with several plotlines and asked to recall whether any past life experiences are relevant to that type of plotline. This exercise is meant to find the most compelling narratives or defining experiences in the user's life. An example of one such plotline or prompt would be:
ROLE-REVERSAL EXPERIENCE. An unanticipated event or circumstance causes you to switch roles with someone who is in a superior position to you (but, in an ideal world the roles would be the other way around). This plot involves you stepping up or stepping in to help fill someone else's shoes, and the growth that accompanies that.

Other prompts or plotlines may be used, as understood by the person skilled in the art. Several examples may be available on the tutorial system website.

Step 3. Recording brainstormed experiences: the user is then instructed to take any experience(s) relevant to the plotline that is held in memory and transcribe them onto the word processor. Referring to FIG. 4, the user will do this by transferring a model from the resource box (405) into the word processor (410) that will guide the user in breaking the experience down into, for example, a 5-point outline (or an outline consisting of a specified number of points). In another embodiment of the invention, the model may be automatically transferred upon the user beginning that step. An example of a 5-point outline (or an outline consisting of a specified number of points) could be:
1. What is your want?
2. What is your complication?
3. How did you react to this complication?
4. Why is this story meaningful to you?
5. What does this story (at its core) communicate to the reader about the kind of person that you are (i.e. the big picture)?

If the user cannot answer all 5 points of the above outline, the experience should not be written about in a college essay—but it may be suitable for the additional/optional information section.

Step 4. In order to distinguish a compelling experience (i.e. one that is essay worthy) from a non-compelling story (i.e. additional information potential): the student must then answer YES to all of the 5 yes/no questions below:

Test for Essay Potential
1. Is this story about a special character building experience? Yes/No.
2. Is the main character better off at the end of the story than when the story began? Yes/No.
3. Does the main character not just think differently because of that experience, but he turns that reaction into further action (or a ripple effect)? Yes/No.
4. Does the main character still live by the lesson(s) he or she learned from that experience today (test of long-term meaning/significance)? Yes/No.
5. Does the story have moment(s) that made the main character stop and think about 1 (or more) of the following 2 concepts: how he thinks or what he values? Yes/No.

If the user cannot answer YES to all questions above, the experience should not be written about in a college essay—but it may be suitable for the additional/optional information section.

Step 5: Repeat steps 1 through 3 for each plotline or experience presented to the user.

Step 6. Once all the plotlines have been presented, and all the experiences have been tested for essay potential, the user will be instructed to identify the best experience to write an essay about, using tests and self-evaluation tools, which may be presented to the user in any order, to narrow down the user's options. For example:

A) Justification of Space Test (example of a self-evaluation tool):
Can you explain the experience in approximately 1,000 words or less (i.e. about the size of a paragraph) without feeling like important elements of the message you want to share about your character's thinking and feeling halves are lost? Yes/No.
If you wrote a one page essay about the experience, would you need the need to repeat information, add “fluff”, or “superfluous details” to fill up the one page of space? Yes/No.
Do you feel this essay would be hard to write because you'd have a hard time thinking of what to say about the experience? Yes/No.
   If the user answers YES to any question above: the experience should not be written about in a college essay.

B) Actual Significance to You Test (example of a self-evaluation tool):
If the experience is about your involvement in an activity from your activity sheet, can you answer YES to any of the following questions?:
   Is the activity one of the top 3 activities you've dedicated the most time to in terms of hours/week or weeks/year? Yes/No.
   Is the activity one you picked up only recently but has been one of the top 3 activities that you are currently dedicating more hours per week and weeks per year to? Yes/No
If the experience is not about your involvement in an activity from your activity sheet, is the story about a developmental period of your character's thinking or feeling half that explains the “present-day version of you” in any of the following ways?
   Why you make the kinds of decisions you do today? Yes/No
   Why you act or behave the way you do today? Yes/No
   Why you are able to achieve the things you do today (or will do in the future)? Yes/No
   Why you have the goals you have today? Yes/No
   Why you have the wants or desires you have today? Yes/No
   If the user cannot answer YES to at least one of the questions above. The experience should be mentioned in additional information and not the personal statement or an activity essay (i.e. short answer response),

C) Story Ends on a High Note Test (example of a self-evaluation tool):
Does the story end on a note that's positive, yet? Yes/No.
Does the story end with your momentum increasing (instead of decreasing, being set back, or leveling off)? Yes/No.
   If the user answers NO to any question above: the experience should not be written about in a college essay—but may be suitable for the additional/optional information section, especially if the story is meant to explain why the user does not meet academic or performance expectations (i.e. low grades, medical condition).

D) Extenuating Circumstance Test (example of a self-evaluation tool):
Is the motivation for sharing this experience to explain why your academic performance is not as high as it could be? Yes/No.
Is the motivation for sharing this experience to explain why you have burdens, responsibilities, or challenges others students don't have in their lives that force you to exert more effort to achieve the same academic or performance results your peers achieve, but you haven't overcome it yet? Yes/No.
   If the user answers YES to the question above: the experience should not be written about in a college essay or activity essay (e.g. short answer response)—but should be put in the additional/optional information section.

E) Multiple Plot-line Test (example of a self-evaluation tool):
Did the experience apply to more than one of the plot-lines you were presented by the tutorial? Yes/No.
   The more plot-lines the experience applies to, the more the experience is deep and multi-faceted—and therefore, the more plot-lines an experience is applicable to, the more it should be considered stronger potential essay topic over your other potential essay topics.

F) Answers the College Application's Prompt Test (example of a self-evaluation tool):
Is the experience relevant to the college application essay prompt that you are ultimately responding to (i.e. it can be used to directly answer the question)? Yes/No.
   If the user answers YES to the question above: topic can be used for the essay.

G) Non-Overlap Test (example of a self-evaluation tool)::
Is the message that you want to communicate by writing about this experience already communicated in an earlier part of the college application (e.g. through an activity sheet or activity essay that admissions officers will read before they read your essay)? Yes/No.
   If the user answers YES to the question above: topic should not be used for the essay.

H) Supplemental Application Test (example of a self-evaluation tool)::
If the message that you want to communicate by writing about this experience will be communicated in a later part of the college application, is it a supplement that not all of your colleges will receive (e.g. a school specific supplemental essay)? Yes/No.
   If the user answers YES to the question above: topic should still be considered for the essay because not all of the user's colleges will see the supplemental application.

Another system that can be used in the disclosure is the Essay Outlining System.

The Essay Outlining System. Whereas the prior art helps students create outlines by giving them a generalized rhetorical purpose for each paragraph (e.g. the first paragraphs are the topic sentence or thesis paragraph, the body paragraphs are supporting evidence paragraphs, the last paragraph is a conclusion), the tutorial system of the disclosure more specifically helps students build an “outline of their outline” so they know exactly what ideas, thoughts, events, actions, and concepts to include in each paragraph of their outline. In other words, the tutorial system of the disclosure not only gives students a generalized purpose for each paragraph, but it also helps them learn exactly what to say in each paragraph and even construct each paragraph idea-by-idea. In one embodiment, the Essay Outlining System may comprise the following types of steps. However, rather than being a verbatim depiction of said system, the following representation depicts the general types of methods, models, templates, systems, start to finish concept that are combined to control a user's thoughts and actions.

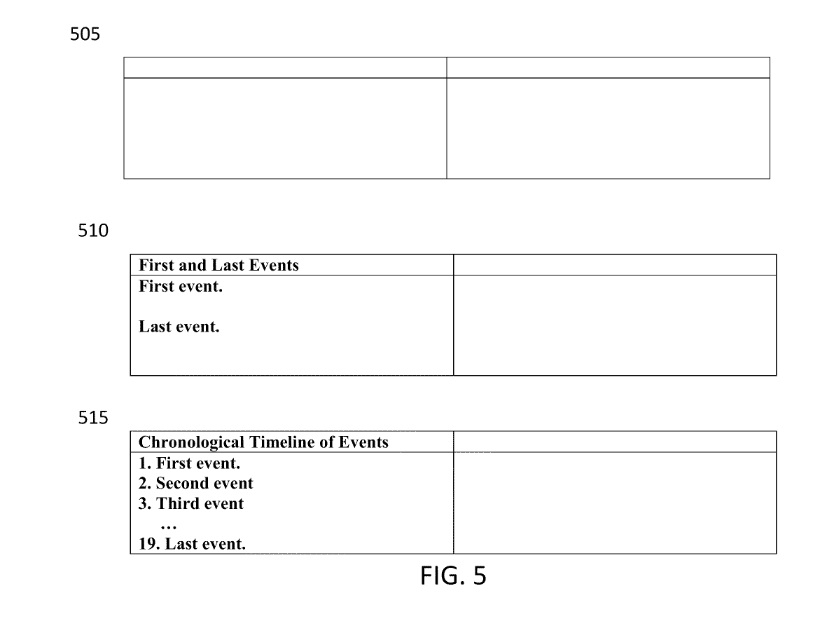

Step 1. The student transfers, creates, or uses a two-column table in his or her word processor. For example, referring to FIG. 5, a two column table (505) is created. Referring now to FIG. 1, this table could be transferred from the resource box (104) into the word processor (100), or the student can be instructed by the AN instructions (101) on how to create a table in his or her native word processor. Alternatively, the two-column table may have been preloaded into the student's word processing document.

Step 2. Using the story the student chose from the previous part of the tutorial, the Essay Brainstorming System, the student can then be guided on how to frame the story by determining the first and last events in the story. Referring to FIG. 5, this step is depicted as (510). This frames the time frame and scope of events that the story will span.

Step 3. The student can then be guided on how to establish a chronological timeline of events in the left column that connect the first event to the last event. This creates the step-by-step “action plot” of the story. This step is depicted in (515).

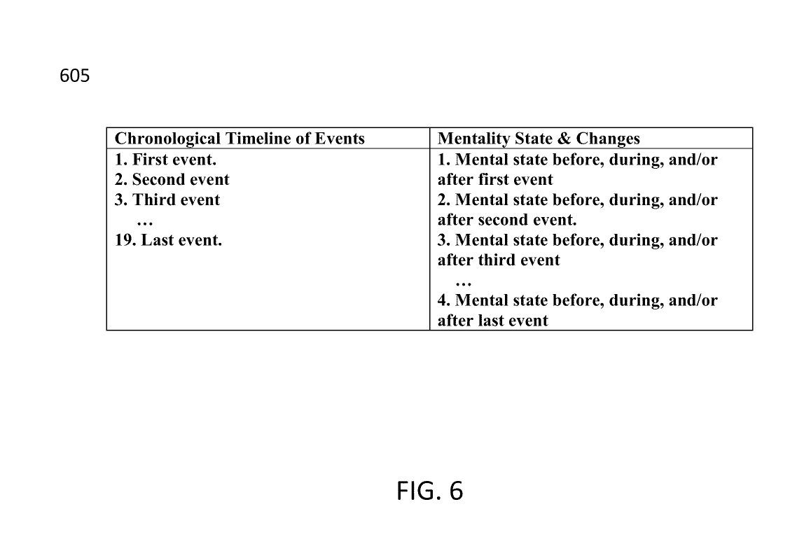

Step 4. The student can then be guided on how to map his or her mental state, impressions, thoughts, feelings, growth, perspective, vision, internal change, etc. at each event in the right column. This creates the “character” element of the story, or the internal journey of the character that parallels each part of the story's action plot. Referring to FIG. 6, this step is depicted in (605).

Step 5, The student can then be guided on how to revisit each mentality change and apply the “4-why exercise”: an exercise that requires the student to take the given mentality entry and ask himself or herself 4 or more reiterations of the question ‘why’ in order to discover deeper meaning/significance. For example, take the statement: “I like video games”.

WHY>I've been playing them all my life since I was 3.

WHY>I was always interested in learning about them.

WHY>they are fun, they make me happier.

WHY>they allow me to immerse myself in another world

CONCLUSION: I like video games because I like immersing myself in other worlds.

The student above would explain he likes video games (i.e. the outlet of his core passion) because he likes immersing himself in other worlds (i.e. his core passion). This is important because in order for the user to ensure that his reader will understand the extent and composition of his character qualities, he must articulate the motivations (or core passions) that underlie his actions.

Step 6. Once the chronological events and mentality states are all mapped out and deepened with the 4-why exercise of step 5, and included in the table (605), the student can then be guided on how to start outlining the first paragraph. Referring to FIG. 4, in the following steps the student will transfer templates from the resource box (405) of the tutorial system into the word processor (410).

The tutorial system can explain to the user the meaning of different stylized parts of a template. Such templates may be stylized with colors or different fonts or font stylings. For example a template key may comprise:

BLUE TEXT=MACRO IDEAS THAT NEED TO BE COVERED IN PARAGRAPH

ORANGE TEXT=THE STRATEGIC PURPOSE OF PARAGRAPH

BLACK ITALICS=THE MICRO FLOW OF IDEAS IN PARAGRAPH (THAT WILL MAKE YOUR WRITING INTERESTING)

Step 7. To begin outlining the first paragraph, the student can be instructed to transfer a template from the tutorial into his word processor. For example:
Enticing Incident [something happens]
(“Bring the reader into the time of a specific incident. Goal: start the essay with the most recent, intense emotional experience in your story and reveal your want. Note: Paragraphs 2-4 will develop your story by working backwards from this point. The conclusion paragraph will be your commentary on impact the story had on you.”):
Emotion [directly or indirectly express: what did you feel?]
Context [what made you feel that way?]
Description [what is happening?]
Reaction [directly or indirectly express: what you felt or realized next]

The A/V instructions of the tutorial can instruct the student on how to identify the best events and mentality states (from the chronological timeline table) to include in the enticing incident paragraph. Then the A/V instructions can instruct the student to use the highlighter tool to apply a specific color to each event or mentality state that qualifies for that paragraph (i.e. color code).

Step 8. To begin outlining the second paragraph, the student can be instructed to transfer a template from the tutorial into his word processor. For example, referring to FIG. 4, the student can transfer templates from the resource box (405) of the tutorial system into the word processor (410). For example:
Rising Action [character development]
(“Give the reader a window into who you are. Goal: the purpose of this paragraph is to provide backstory (character development) so that the reader can learn about the person that the enticing incident has happened to (i.e. the user). It provides a window into your life that occurs either before or after the enticing incident happens but adds significance to that moment.”)
Reveal your character by either explaining: [1] how you came to find yourself in the general position you are in when the enticing incident happens, or [2] what you were enticed to do after the enticing incident happened. Either way, you need to develop your internal thoughts/motives.

Again, the audio portion of the tutorial (A/V instructions) can instruct the student on how to identify the best events and mentality states (from the chronological timeline table) to include in the rising action paragraph. Then the A/V instructions can instruct the student to use the highlighter tool to apply a different color to each event or mentality state that qualifies for that paragraph (i.e. color code).

Step 9. To begin outlining the third paragraph, the student can be instructed to transfer a template from the tutorial into his word processor. For example:
Choose one: a Climax [breaking into your highest or lowest point] or a Turning Point [pivot]
(“Note: You will either flash back to a prequel climax or previous turning point that occurs before the enticing incident happened, which adds significance to the actions you take in the falling action paragraph; or you will move the story forward into a moment that directly follows from the enticing incident”;):

Again, the audio portion of the tutorial (A/V instructions) can instruct the student on how to identify the best events and mentality states (from the chronological timeline table) to include in the climax or pivot point paragraph. Then the A/V instructions can instruct the student to use the highlighter tool to apply a different color to each event or mentality state that qualifies for that paragraph (i.e. color code).

Step 10. To begin outlining the fourth paragraph, the student can be instructed to transfer a template from the tutorial into his word processor. For example:
Falling Action [culmination of your story]
(“Wrap up and end your narrative”):
This is the end of your narrative.

Again, the audio portion of the tutorial (A/V instructions) can instruct the student on how to identify the best events and mentality states (from the chronological timeline table) to include in the falling action paragraph. Then the A/V instructions can instruct the student to use the highlighter tool to apply a different color to each event or mentality state that qualifies for that paragraph (i.e. color code).

Step 11. To begin outlining the fifth paragraph, the student can be instructed to transfer a template from the tutorial into his word processor.
Conclusion [Reflection]
(“Explain the big-picture or long-term meaning and significance of the overall impact this experience has had on you”):
Refer back to the prompt to ensure you're answering it.

Again, the audio portion of the tutorial (A/V instructions) can instruct the student on how to identify the best events and mentality states (from the chronological timeline table) to include in the conclusion paragraph. Then the A/V instructions can instruct the student to use the highlighter tool to apply a different color to each event or mentality state that qualifies for that paragraph (i.e. color code). In other embodiments of the Essay Outlining System, a model for developing written compositions that are more or less than 5 paragraphs (or in the form of a poem or another structural format for writing) may be provided to compose the user's written work.

Step 12. When the user has all of his events and mentality states appropriately highlighted to correspond with the appropriate paragraph: the user can now go back to each paragraph and articulate a personalized synopsis (that replaces the orange text) for each paragraph as it relates to his or her personal story.

The synopsis for each paragraph can be one or a few lines long and each paragraph's synopsis will essentially distill what the main purpose of each paragraph in the student's story is essentially about.

The following is an example of what the student could see in the word processor (it's the culmination of transferring each template from previous steps):
Enticing Incident [Something Happens]
(orange text: “Time of the Incident: Mom doesn't trust that Katie can take over, Katie gets angry and decides to prove her wrong”):
Rising Action [explains: why it was significant to you and what did the enticing incident prompt you to do next?]
(orange text: “Mom lacks trust and confidence in Katie's abilities throughout high school”):
Turning Point [The story pivots on a decision, realization, or experience you have (or had before or after the time of the enticing incident occurred)]
(orange text: “Time of the Incident: Katie takes action and proves her independence and responsible nature, mom begins to recognize it”):
Falling Action [Actions or events (or internal & external conflicts) resolve]
(orange text: “Katie builds a better relationship with mom”):
Conclusion [How the events of this story gave you a perspective, attitude, etc. that drives the decisions and actions you make today.]
(orange text: “Understanding and appreciation of independence, Katie is confident to leave for college”):

Note: the A/V instructions can walk the user through a “walk through” exercise that helps the user realize what the purpose/focus of each paragraph's synopsis should be. This synopsis guides the user's development of each individual paragraph. Additionally, the A/V instructions can help the student create a master synopsis for the entire story which guides the user's development of the overall story.

Step 13: The audio can direct the student to review his or her paragraph master synopsis and outline in its entirety.

Step 14. The student can turn away from the screen and pretend that she is pitching a TV show to someone. The student can recite the pitch out loud beginning with the master synopsis while referring to herself in the 3^{rd} person and reciting from memory. In this step, the student can also be instructed to record himself pitching (using a recording device) so that he can listen and write down valuable things that he says when reciting his story verbally). The user can repeat this game until she fully memorizes and understands the outline. This exercise could not only help the user recall new details, but it could also program the outline into his memory so he'll have a better command of the story's vision and direction when he begins writing.

Step 15: The student is ready to begin the first draft of the essay. The person skilled in the art will understand that in the above, other forms of writing as involved in admissions applications may be substituted for the essay. For example, the steps above may be applied to writing a personal statement, statement of purpose, autobiographical essay, diversity statement, cover letter, poem, example of written work, etc.

In one embodiment, another part of the tutorial system comprises the Macro Editing System.

The Macro Editing System. This system can help students edit or revise their first draft of their essay. It may comprise the following steps. However, rather than being a verbatim depiction of said system, the following representation depicts the general types of methods, models, templates, systems, start to finish concept that are combined to control a user's thoughts and actions.

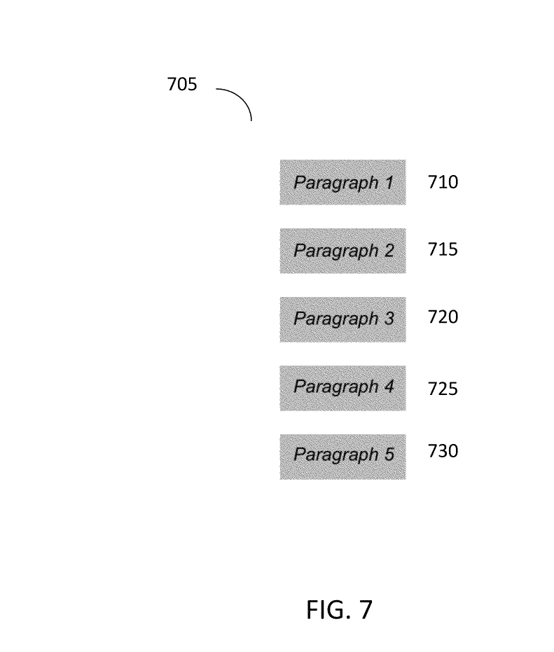

Step 1: The user may have written, for example, a 5-paragraph essay using the Essay Outlining System (described above). Referring to FIG. 7, each paragraph written by the user can be represented by a grey box (705).

Step 2: The system can explain that there may be, for example, 4 stages of editing. The four stages in order of first (i.) to last (iv.) may comprise:
MACRO EDITING
   i. Content Deals strictly with idea relevancy.
      1. Edit/redo the original outline if the originally envisioned story didn't pan out.
      2. Arrange the content in the first draft so that it stays true to the current outline.
      3. Move sentences to another paragraph if necessary.
      4. Develop underdeveloped ideas (i.e. probe to find deeper meaning and significance).
      5. Delete irrelevant sentences/ideas.
   ii. Structure Deals strictly with the arrangement and order of ideas.
      1. Improve the order in which ideas are introduced in each paragraph to create r flow (of ideas) throughout each paragraph.
      2. Improve the order in which ideas are introduced within each sentence to create better flow (of ideas) throughout each sentence.
MICRO EDITING
   iii. Syntax deals with construction of sentences for clarity and potency.
   iv. Grammar deals with word count reduction, surface polishing.

The student may be informed that the Macro Editing System deals only with content and structure editing.

Step 3. This step may comprise dealing with CONTENT: Edit/redo the original outline if the originally envisioned story didn't pan out. Content is step i. above. In step 3, the user may be instructed to transfer or lay the outline developed with the Essay Outlining System (referred to hereafter as “scaffolds”) over the user's current first draft as follows:
Enticing Incident [Something Happens](orange text: “Time of the Incident: Mom doesn't trust that Katie can take over, Katie gets angry and decides to prove her wrong”)
Student's draft of the enticing incident paragraph (705 in FIG. 7).
Rising Action [explains: why it was significant to you and what did the enticing incident prompt you to do next?]
(orange text: “Mom lacks trust and confidence in Katie's abilities throughout high school”)
Student's draft of the rising action paragraph (710 in FIG. 7).
Turning Point [The story pivots on a decision, realization, or experience you have (or had before or after the time of the enticing incident occurred)]
(orange text: “Time of the Incident: Katie takes action and proves her independence and responsible nature, mom begins to recognize it”)
Student's draft of the turning point paragraph (715 in FIG. 7).
Falling Action [Actions or events (or internal & external conflicts) resolve]
(orange text: “Katie builds a better relationship with mom”)
Student's draft of the falling action paragraph (720 in FIG. 7).
Conclusion [How the events of this story gave you a perspective, attitude, etc. that drives the decisions and actions you make today.]
(orange text: “Understanding and appreciation of independence, Katie is confident to leave for college”)
Student's draft of the conclusion paragraph (725 in FIG. 7).

The user may also be instructed to transfer new guides provided in the resource box (104 of FIG. 1) into the draft of his essay in the word processor (100 from FIG. 1) which serve as additional scaffolds for editing. The guides may be placed before, after, or in between one or more paragraphs to focus the student on developing only one aspect of the written work at a time (i.e. in piecemeal).

Step 4. The user can read the essay in its entirety with the scaffolds in place to ensure that each sentence supports the goal of that paragraph (as expressed in the blue and orange outline header). But, no edits to the work are to be made during this reading. The student is only allowed to highlight. This ensures the student reads with a big-picture perspective. For example, As the student reads, the user may:
i. Highlight any material that can be deleted in grey
ii. Highlight any material that belongs in another paragraph in green
iii. Highlight any material that should be developed further in orange
iv. Highlight key material that needs to be emphasized in yellow

Step 5: Once highlights are made, the user can to examine each paragraph separately and individually, and the user can be allowed to make the following edits:
a. Delete the irrelevant sentences/ideas
b. Move sentences to another paragraph if necessary
c. Develop underdeveloped ideas (i.e. probe to find deeper meaning and significance).
d. Deepen thoughts and meaning.

Step 6: In this step, after the user ensures that each sentence of a paragraph is relevant to (and supports) the goal of that paragraph (according to that paragraph's synopsis and instruction from the tutorial), the user may then be walked through a “walk through” exercise on how to re-order sentences and ideas within each paragraph in order to create better idea flow. The goal here comprises making sure that, from the first-to-last sentence, the thoughts of a reader are guided in the best way possible. Models or transferrable templates may be provided by the tutorial system for this step as well.

Step 7: Once the original outline and current draft of the user's essay are in harmony, and each paragraph is in workable order, the user can be given a set of instructions on how to approach and solicit feedback from peers, teachers, family members, etc. The instructions may require the user to ask third parties various, guided “yes/no” questions about his draft in an attempt to validate whether his intended message is effectively being communicated to, and understood by, his readers. The user can also receive instructions that can help him improve the thought composition and internal structure of his or her entire essay as well as within each paragraph. A core element of the third party critique is asking third parties to rank certain parts of the essay on a 1 to 10 scale. The student can then ask what would make the essay one mark higher (e.g. if it was rated a 9, the student would ask what would make it a 10; if it was rated a 10, the student can ask what would make it an 11).

Step 8: The user can then be instructed on how to interpret and incorporate the feedback he receives into the current draft of his work product. If the intended message is not being effectively communicated to, or fully understood by, readers, the user can be instructed on how to fix that by assessing what third party reviewers perceive to be the message and how that differs from the message the writer actually intends to express. Then, the user can be instructed on methods to bridge that divide.

Step 9: Once the user's intended message is fully understood by third party reviewers, the user can be ready for micro editing (and word or character cutting to fit the word or character limit if one is imposed by his admissions application).

In one embodiment, another system part of the tutorial system may be the Micro Editing System. However, rather than being a verbatim depiction of said system, the following representation depicts the general types of methods, models, templates, systems, start to finish concept that are combined to control a user's thoughts and actions.

The Micro Editing System. This system can help students avoid common grammatical and sentence syntax mistakes. It can also convey clever syntax tricks that cut the essay's word count by saying fewer words that convey greater detail. Third party reviews may also be incorporated, similarly to the Macro Editing System.

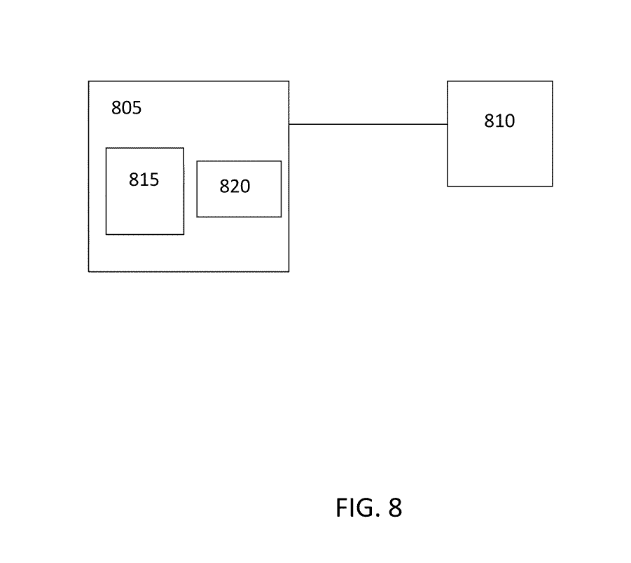

Referring now to FIG. 8, a web-based tutorial system is described. Such a system may comprise any of the embodiments described in the present disclosure, and may incorporate a tutorial system device (805), the tutorial system device comprising a number of display regions, for example (815) and (820). Each display region may be configured to display any of the tutorial system components described in the disclosure. For example, (815) may display a word processor, and (820) may display a resource box component. The tutorial system (805) may connect to a server (810), wherein the server contains up-to-date resources and algorithms, such as templates, models and prompts, in order for the tutorial system (805) to download such resources and algorithms to a user device. A user device, as understood by the person skilled in the art, may comprise a personal computer, a tablet, a mobile phone, or other hardware devices.

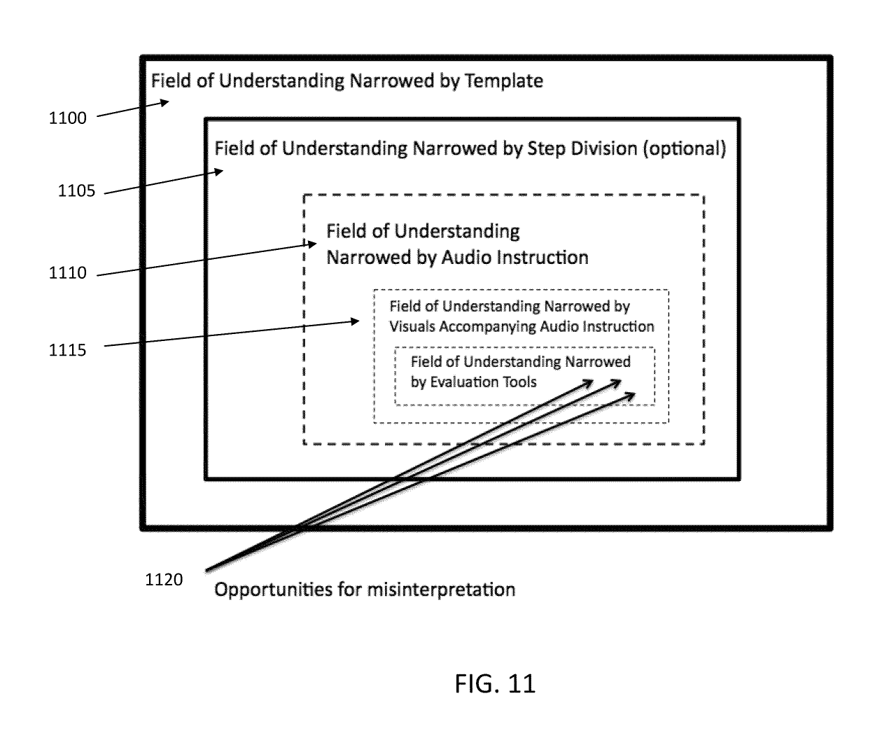

FIG. 11 illustrates a method to iteratively narrow a shared understanding between the student or user of the tutorial system, and the tutorial system. For example, a tutorial system may have a field of understanding regarding a word, an activity or a topic. The user or student may have a different understanding of that word, activity, or topic. By iteratively verifying the understanding, the system can make sure that the user or student is following the tutorial system as intended. For example, a sequence of questions or additional activities may be supplied to the user or student, who then can provide answers. Through the answer or response, the system can determine whether or not there is any misunderstanding. The field of understanding can then be progressively narrowed until a common understanding is reached.

For example, a first field of understanding can be reached by providing a template to the user (1100). A second field of understanding, narrower than the first, can be reached by a division of the activity into steps (1105). A third field of understanding can be reached by audio instructions (1110). A fourth field of understanding can be reached by visuals accompanying audio instructions (1115). A fifth field of understanding can be reached by evaluation tools (1120). In this way possibilities for misinterpretation can be avoided.

In some embodiments, the methods of the present application may comprise dividing the required activities of a school application into sequential steps, and each step into substeps. Audio instructions may be given to the student to help them complete each step and substep, and visual instructions may accompany the audio instructions. Evaluation tools may be used to evaluate the successful completion of each step on the part of the student, and according to the audio and/or visual instructions.

In some embodiments, the tutorial system comprises a display system. An embodiment of the display system is software that provides instructions for creating the display.

An example of a misunderstanding is a disconnect of ideas between the concepts understood by the user and the concepts understood by the system.

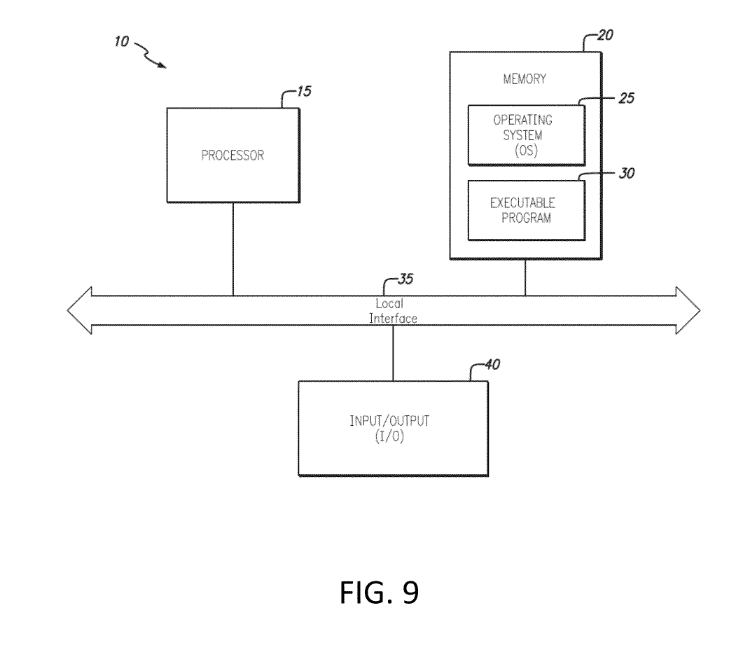

FIG. 9 is an exemplary embodiment of a target hardware (10) (e.g. a computer system) for implementing the embodiments of FIGS. 1 to 8. This target hardware comprises a processor (15), a memory bank (20), a local interface bus (35) and one or more input/output (I/O) devices (40). The processor may execute one or more instructions related to the implementation of FIGS. 1 to 8, and as provided by the operating system (25) based on some executable program stored in the memory (20). These instructions are carried to the processors (20) via the local interface (35) and as dictated by some data interface protocol specific to the local interface and the processor (15). It should be noted that the local interface (35) is a symbolic representation of several elements such as controllers, buffers (caches), drivers, repeaters and receivers that are generally directed at providing address, control, and/or data connections between multiple elements of a processor based system. In some embodiments the processor (15) may be fitted with some local memory (cache) where it can store some of the instructions to be performed for some added execution speed. Execution of the instructions by the processor may require usage of some input/output device (40), such as inputting data from a file stored on a hard disk, inputting commands from a keyboard, outputting data to a display, or outputting data to a USB flash drive. In some embodiments, the operating system (25) facilitates these tasks by being the central element to gathering the various data and instructions required for the execution of the program and provide these to the microprocessor. In some embodiments the operating system may not exist, and all the tasks are under direct control of the processor (15), although the basic architecture of the target hardware device (10) will remain the same as depicted in FIG. 9. In some embodiments a plurality of processors may be used in a parallel configuration for added execution speed. In such a case, the executable program may be specifically tailored to a parallel execution. Also, in some embodiments the processor (15) may execute part of the implementation of FIGS. 1 to 8, and some other part may be implemented using dedicated hardware/firmware placed at an I/O location accessible by the target hardware (10) via local interface (35). The target hardware (10) may include a plurality of executable program (30), wherein each may run independently or in combination with one another.

The examples set forth above are provided to those of ordinary skill in the art a complete disclosure and description of how to make and use the embodiments of the gamut mapping of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The methods and systems described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A tutorial system for formulaic writing of content for written components of school applications, the tutorial system comprising a display system configured to produce a display, the display including:
a first display region configured for word processing;
a second display region configured for providing audio and/or video instructions;
a third display region comprising a next step button;
a fourth display region comprising a back step button;
a fifth display region configured for providing resources, wherein the resources comprise models and/or templates, and further comprises a cycle button configured to enable the user to cycle through different resources;
a sixth display region comprising a transfer button, wherein the use of the transfer button causes:
a transfer of resources from the fifth display region into the first display region or copies the resource from the fifth display region so the user can manually paste the resource into the first display region; and
a seventh display region, comprising menu options.

2. The tutorial system of claim 1, further comprising at least one of the following systems: an activity sheet or resume system, an essay brainstorming system, an essay outlining system, a macro editing system, and a micro editing system.

3. A web-based tutorial system for formulaic writing of unique content for written components of school applications, the tutorial system comprising:
a tutorial system device, comprising a display system configured to produce a display, wherein the display includes:
a first display region configured for word processing;
a second display region configured for providing audio and/or video instructions;
a third display region comprising a next step button;
a fourth display region comprising a back step button;
a fifth display region configured for providing resources, wherein the resources comprise models and/or templates, and further comprises a cycle button to cycle through different resources;
a sixth display region comprising a transfer button, wherein the transfer button:
transfers resources from the fifth display region into the first display region or
copies the resource from the fifth display region so the user can manually paste the resource into the first display region;
a seventh display region, comprising menu options;
a tutorial system server, wherein the server is configured to provide resources and algorithms to the tutorial system device;
wherein the tutorial system device and the tutorial system server are configured to communicate with each other.

4. The web-based tutorial of claim 3, wherein the tutorial system device further comprises at least one of the following systems: an activity sheet system, an essay brainstorming system, an essay outlining system, a macro editing system, and a micro editing system.

5. The tutorial system of claim 1, wherein the fourth display region comprises a word processor.

6. The web-based tutorial system of claim 3, wherein the fourth display region comprises a word processor.

7. A method for tutoring students in formulaic writing of unique content for written components of school applications, the method comprising:
providing a computer running a web based tutorial system;
prompting a student, by the computer, for a list of activities;
tutoring, by the computer, the student in organizing the list of activities by arranging their order into a suggested sequence;
asking the student a set of questions about life events, thereby suggesting to the student a method for brainstorming essay topics;
submitting prompts to the student, by the computer, thereby outlining an essay;
guiding the student in macro editing, by the computer, the essay by following a first set of editing steps;
guiding the student in micro editing, by the computer, the essay by following a second set of editing steps.

8. The method for tutoring students in formulaic writing of unique content for written components of school applications of claim 7, further comprising:
supplying the students with thought models, articulation models, YES/NO checklists, and/or evaluation tools for self-evaluation, quality control, and grading.

9. The method for tutoring students in formulaic writing of unique content for written components of school applications of claim 7, further comprising:
expressing a word, sign, or symbol by audio/visual instructions, thereby establishing a common reference for the word, sign, or symbol between the audio/visual instructions and the students, thereby avoiding misunderstandings.

10. A method for tutoring students in formulaic writing of unique content for written components of a school application, the method comprising:
providing a computer running a web based tutorial system;
tutoring, by the computer, a student in organizing a list of required activities by dividing the list of required activities into a first set of sequential steps, wherein the first set of sequential steps comprises a first set of sequential substeps;
tutoring, by the computer, a student in developing a description for each required activity by completing a first template in a second set of sequential steps, wherein the second set of sequential steps comprises a second set of sequential substeps;
tutoring, by the computer, a student in finalizing a description for each required activity by applying self-evaluation tools in a third set of sequential steps, wherein the third set of sequential steps comprises a third set of sequential substeps;
tutoring, by the computer, a student in interpreting a prompt from an application by pairing the application with an alternative prompt or template;
tutoring, by the computer, a student in brainstorming experiences to write a story about, by prompting the student with examples or templates of types of experiences that the student is asked to recall parallel experiences from in a fourth set of sequential steps, wherein the fourth set of sequential steps comprises a fourth set of sequential substeps;
tutoring, by the computer, a student in finding a storyline in any brainstormed experience by completing a second template in a fifth set of sequential steps, wherein the fifth set of sequential steps comprises a fifth set of sequential substeps;
tutoring, by the computer, a student in choosing one of the brainstormed experiences to write a story about, by having the student apply self-evaluation tools in a sixth set of sequential steps, wherein the sixth set of sequential steps comprises a sixth set of sequential substeps;
tutoring, by the computer, a student in outlining an essay by having the student complete each field of a table with multiple rows and columns in a seventh set of sequential steps, wherein the seventh set of sequential steps comprises a seventh set of sequential substeps;
tutoring, by the computer, a student in outlining an essay by using the information from the table to complete a third template in an eighth set of sequential steps, wherein the eighth set of sequential steps comprises an eighth set of sequential substeps;
tutoring, by the computer, a student in developing a draft of an essay by having the student use a fourth template to write the essay in a ninth set of sequential steps, wherein the ninth set of sequential steps comprises a ninth set of sequential substeps; and
tutoring, by the computer, the student in completing each of the sets of sequential steps and substeps, wherein the completing comprises, at each sequential step of each set of sequential steps, integrating said sequential step into the school application.

11. The method of claim 10, further comprising providing, by the computer, audio instructions for at least one of the sequential steps.

12. The method of claim 11, further comprising providing, by the computer, visual instructions correlated to the audio instructions.

13. The method of claim 12, further comprising evaluating, by the computer, an understanding of the student of the audio and/or visual instructions.

14. The method of claim 13, further comprising iteratively narrowing, by the computer, a field of agreement for the understanding of the student of the audio and/or visual instructions.

15. The tutorial system of claim 1, wherein the models and/or templates are incorporated in a pre-existing word processor document.

16. The method of claim 10, wherein at least one of the first, second, third, and fourth templates are incorporated in a pre-existing word processor document.
